(19) United States
(12) Patent Application Publication
(10) Pub. No.: US 2023/0316927 A1
(43) Pub. Date: Oct. 5, 2023

(54) METHOD AND SYSTEM FOR OPERATION OF FLEET VEHICLES

(71) Applicant: Gatik AI Inc., Palo Alto, CA (US)

(72) Inventors: Apeksha Kumavat, Palo Alto, CA (US); Gautam Narang, Palo Alto, CA (US); Arjun Narang, Palo Alto, CA (US); Shaurya Agarwal, Palo Alto, CA (US); Sam Saad, Palo Alto, CA (US); Engin Burak Anil, Palo Alto, CA (US)

(21) Appl. No.: 17/962,459

(22) Filed: Oct. 7, 2022

Related U.S. Application Data
(60) Provisional application No. 63/253,866, filed on Oct. 8, 2021.

(51) Int. Cl. G08G 1/00; B60W 60/00; B60W 50/10

(52) U.S. Cl. CPC G08G 1/22; B60W 60/00256; G08G 1/20; B60W 50/10; B60W 2420/52; B60W 2420/40; B60W 2756/10; B60W 2556/50; B60W 2555/00

(57) ABSTRACT

A method for operation of fleet vehicles includes collecting a set of inputs; processing the set of inputs to determine a set of actions associated with a vehicle and/or a site; and triggering the set of actions. Additionally or alternatively, the method can include aggregating any or all of the set of inputs, and/or any other suitable processes. A system for operation of fleet vehicles can include and/or interface with any or all of: a computing subsystem, a set of management subsystems, a set of user interfaces, a set of sensors, a set of fleet vehicles, a set of non-fleet vehicles, and/or any other components.

### CROSS-REFERENCE TO RELATED APPLICATIONS

This application claims the benefit of U.S. Provisional Application No. 63/253,866, filed 8 Oct. 2021, which is incorporated in its entirety by this reference.

### TECHNICAL FIELD

This invention relates generally to the autonomous vehicle field, and more specifically to a new and useful system and method for operation of fleet vehicles in the autonomous vehicle field.

### BACKGROUND

Advancements in autonomous vehicle technologies have grown significantly in recent years, leading to a wide expansion in potential use cases for these technologies. One of the major use cases is autonomous trucking, and the industry has a strong desire to automate the delivery of goods.

The inventors have discovered that there are several difficulties in implementing autonomous vehicles for this use case, as the lack of a human onboard the autonomous vehicle can lead to numerous operational inefficiencies at a loading or delivery site of the vehicle. For instance, when the vehicle arrives at a customer site, a human associate of the site may be somewhere else, be otherwise occupied, have already started a loading/unloading process with another vehicle, or be otherwise unavailable. Without a human operator onboard the vehicle to initiate and/or check in on these processes, there can be large operational inefficiencies which result.

Thus, there is a need in the autonomous vehicle field to create an improved and useful system and method for operation of fleet vehicles.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a schematic of a method for operation of fleet vehicles.

FIG. 2 is a schematic of a system for operation of fleet vehicles.

FIGS. 3A-3B depict a use case of the system and/or method implemented in deliveries and a schematic of an associated fleet.

FIGS. 4A-4B depict an example of a user interface for tracking, insights, and/or management of a vehicle.

FIGS. 5A-5B depict an example of a user interface for interacting with a vehicle.

FIG. 6 depicts a schematic example of information flows and/or triggered actions along a delivery route of a vehicle.

FIGS. 7A-7B depict a schematic variation of the management of a set of vehicles interacting with a site.

FIG. 8 depicts a schematic example of information flows between components of a system for operation of fleet vehicles.

FIG. 9 depicts a schematic example of a journey of a set of vehicles to a set of sites.

FIGS. 10A-10C depict a schematic example of the management of a set of vehicles interacting with a site.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

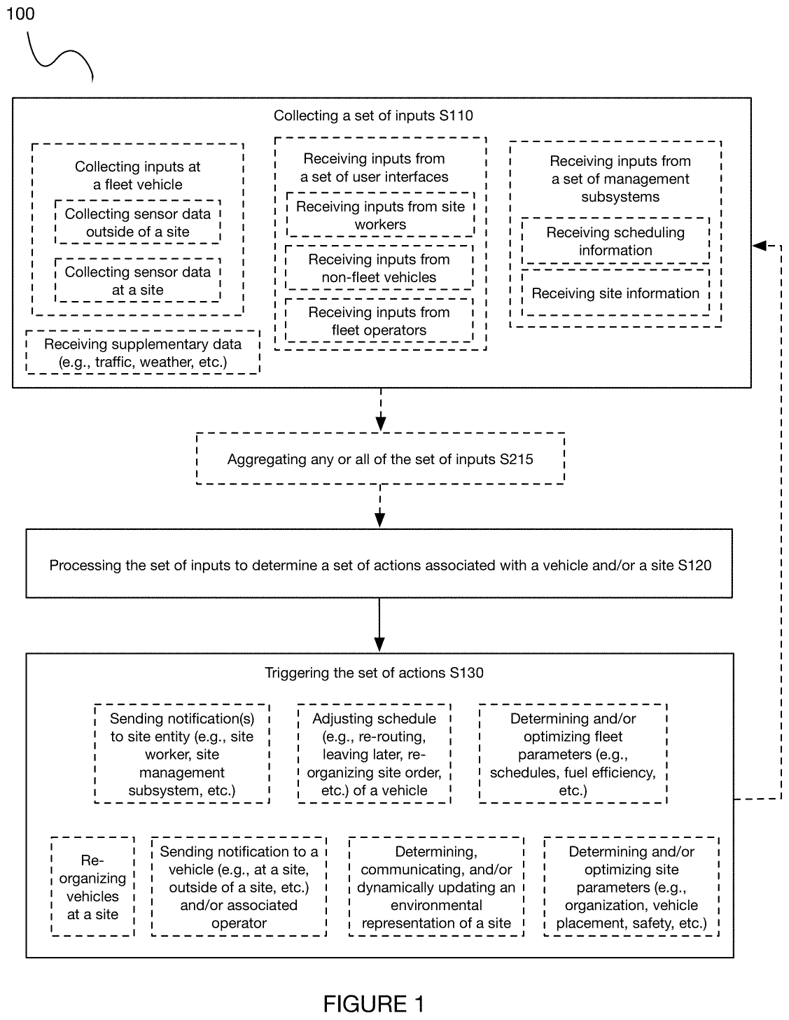

As shown in FIG. 1, a method 100 for operation of fleet vehicles includes collecting a set of inputs S110; processing the set of inputs to determine a set of actions associated with a vehicle and/or a site S120; and triggering the set of actions S130. Additionally or alternatively, the method 100 can include aggregating any or all of the set of inputs S115, and/or any other suitable processes. Further additionally or alternatively, the method 100 can include and/or interface with any or all of the methods, processes, embodiments, and/or examples for operating the ego agent as described in any or all of: U.S. application Ser. No. 17/116,810, filed 9 Dec. 2020; U.S. application Ser. No. 17/125,668, filed 17 Dec. 2020; and U.S. application Ser. No. 17/127,599, filed 18 Dec. 2020; each of which is incorporated herein in its entirety by this reference.

The method 100 is preferably performed with a system 200 as described below, but can additionally or alternatively be performed with any other system(s).

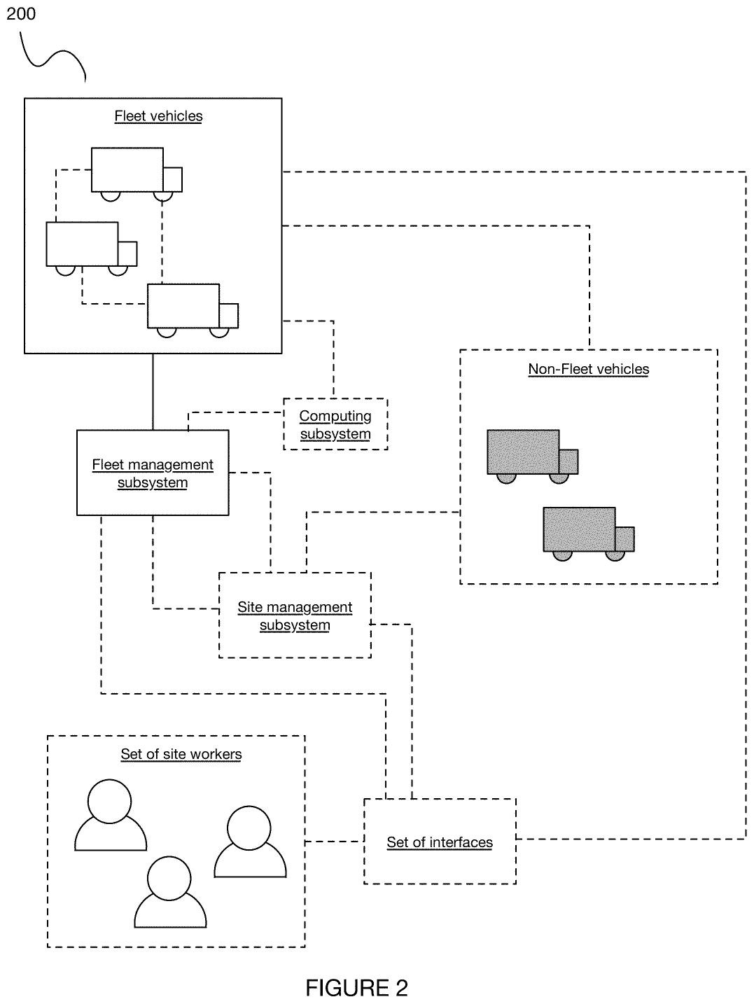

As shown in FIG. 2, a system 200 for operation of fleet vehicles can include and/or interface with any or all of: a computing subsystem, a set of management subsystems, a set of user interfaces, a set of sensors, a set of fleet vehicles, a set of non-fleet vehicles, and/or any other components. Additionally or alternatively, the system can include or all of the components as described in U.S. application Ser. No. 17/116,810, filed 9 Dec. 2020; U.S. application Ser. No. 17/125,668, filed 17 Dec. 2020; and U.S. application Ser. No. 17/127,599, filed 18 Dec. 2020; each of which is incorporated herein in its entirety by this reference.

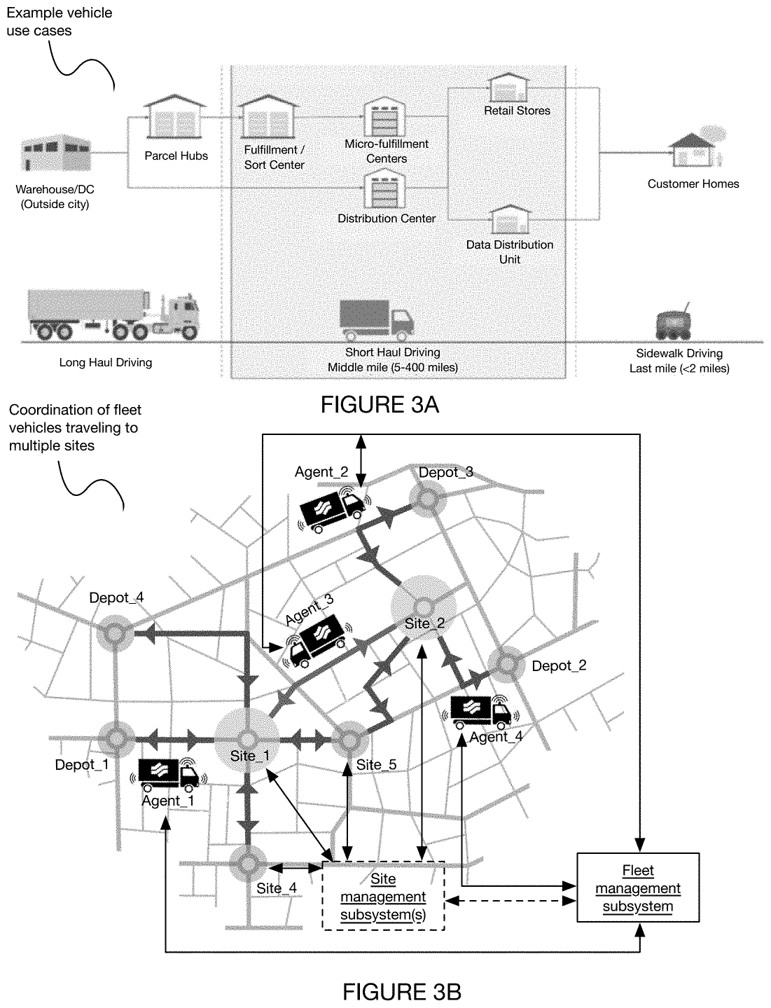

In a preferred set of variations (e.g., as shown in FIGS. 3A-3B), the method and/or system are configured for use in short-haul logistics applications, such as those which use autonomous vehicles to deliver goods between destinations. The autonomous vehicles preferably perform these deliveries according to a set of fixed routes, but can additionally or alternatively follow dynamic routes and/or be otherwise operated.

Additionally or alternatively, the method and/or system can be utilized in any other use cases (e.g., ride share, transportation of people, long-haul logistics, etc.).

### 2. Benefits

The system and method for operation of fleet vehicles can confer several benefits over current systems and methods.

In a first variation, the technology confers the benefit of automatically increasing an efficiency (e.g., operational efficiency) of the loading and/or unloading of an autonomous vehicle at a site, which can in turn prevent buildup of excess vehicles at the site, prioritize and/or optimize the order in which vehicles are attended to (e.g., for unloading at a loading dock), provide instructions to autonomous vehicles at the site, and/or perform any other actions for improving efficiency.

Additionally or alternatively, the technology can confer the benefit of increasing an operational efficiency associated with site(s) through any or all of: dynamic updating of any or all management subsystems associated with a site and/or fleet; vehicle-to-vehicle communications (e.g., among a fleet, between a fleet vehicle and a non-fleet vehicle, etc.) to transmit updated and/or dynamic information; automatically adjusting a routing and/or order of destinations for vehicles; and/or through any other actions or outputs.

In a second variation, additional or alternative to the first, the technology confers the benefit of leveraging the sensors onboard an autonomous vehicle to provide awareness of the conditions at a site (e.g., how crowded the site is, how many other vehicles are at the site, whether or not the site is experiencing a weather-related condition, etc.) and use this awareness to initiate one or more actions for fleet management, optimize an efficiency of the ego agent's set of routes, update an environmental representation of a site to trigger any suitable actions for increased efficiency and/or safety, and/or trigger any other actions.

In a set of examples, for instance, the system and/or method confer the benefit of detecting that a site has limited or no availability for additional vehicles, and in response, adjusting a route (e.g., diverting to another site, waiting at the previous site, etc.) of other vehicles which are en route to the site.

In another set of examples, additional or alternative to those above, the system and/or method confer the benefit of dynamically updating and/or maintaining an environmental representation (e.g., map) associated with a site which is more accurate than that maintained by the site itself (e.g., which require manually entered data from non-AV vehicles, which do not account for the locations of non-vehicle objects such as humans, etc.), which enables deliveries to be optimized for fleet vehicles and/or non-fleet vehicles.

In another set of examples, additional or alternative to those above, the system and/or method confer the benefit of increasing a safety associated with a site, such as those which are over-crowded and associated with an out-of-date understanding of the site management subsystem. In a particular specific example, for instance, a dynamic environmental representation maintained by the fleet management subsystem can provide alerts and/or other actionable insights based on locations of users, locations of objects which might currently be in blind spots of other vehicles, and/or any other information.

In a third variation, additional or alternative to those described above, the technology confers the benefit of collecting and aggregating a corpus of data with which to help customers optimize their site (e.g., site layout) and/or operational protocols of their site. This can be used, for instance, to determine any or all of: how many workers are optimal to have on each shift; which layout of the site is optimal to prevent congestion; how many loading docks should be present at the site; which features of the site cause operational inefficiencies; the average wait time for a vehicle to be loaded and/or unloaded after arriving at the site; and/or any other information.

Additionally or alternatively, the system and method can confer any other benefit.

### 3. System

As shown in FIG. 2, a system 200 for operation of fleet vehicles can include and/or interface with any or all of: a computing subsystem, a set of management subsystems, a set of user interfaces, a set of sensors, a set of fleet vehicles, a set of non-fleet vehicles, and/or any other components. Additionally or alternatively, the system can include any or all of the components as described in U.S. application Ser. No. 17/116,810, filed 9 Dec. 2020; U.S. application Ser. No. 17/125,668, filed 17 Dec. 2020; and U.S. application Ser. No. 17/127,599, filed 18 Dec. 2020; each of which is incorporated herein in its entirety by this reference.

The system is preferably configured for implementation with a set of autonomous vehicles (equivalently referred to herein as autonomous agents, ego agents, etc.), wherein each of the autonomous vehicles is preferably a fully autonomous vehicle and/or able to be operated as a fully autonomous vehicle, but can additionally or alternatively be any semi-autonomous or fully autonomous vehicle, a teleoperated vehicle, and/or any other suitable vehicle. The autonomous vehicle is preferably an automobile (e.g., car, driverless car, bus, shuttle, taxi, ride-share vehicle, truck, semi-truck, etc.), but can alternatively be any or all of: a watercraft (e.g., boat, water taxi, etc.), aerial vehicle (e.g., plane, helicopter, drone, etc.), terrestrial vehicle (e.g., 2-wheeled vehicle, bike, motorcycle, scooter, etc.), and/or any other suitable vehicle and/or transportation device, autonomous machine, autonomous device, autonomous robot, and/or any other suitable device.

The system is further preferably configured for implementation with a fleet of autonomous vehicles, wherein autonomous vehicles of the fleet are managed with a fleet management subsystem (e.g., as described below). This can enable, for instance, vehicle-to-vehicle communications to take place from one vehicle of the fleet to another vehicle of the fleet (e.g., directly, indirectly through the fleet management subsystem), vehicles of the fleet to be controlled and management in ways which optimize a total operational efficiency of the fleet, enable the vehicles of the fleet to combine sensor information in ways which create a complete or most-complete environmental representation of their surroundings (e.g., a site), and/or any other outputs or outcomes can be enabled.

Additionally or alternatively, the fleet can include non-autonomous (e.g., manual) vehicles, autonomous vehicles can be controlled outside of a fleet, any or all of the enabled outcomes and/or outputs can be between fleet vehicles and non-fleet vehicles, and/or the system can be otherwise suitably implemented.

The system preferably includes and/or interfaces with a set of one or more computing subsystems, which individually and/or collectively function to process any or all of the set of inputs received for implementing the method 100 as described below. Additionally or alternatively, the computing subsystem(s) can function to perform actions (e.g., route planning, trajectory planning, obstacle detection, perception, prediction, etc.) for operation of a vehicle (e.g., in combination with a control subsystem [e.g., set of controllers] and/or actuation subsystem [e.g., drive-by-wire subsystem] of the vehicle). Further additionally or alternatively, the computing subsystem(s) can perform any other suitable function(s).

The computing subsystem (e.g., set of computers, set of processors, etc.) can include any or all of: a set of one or more onboard computing subsystems arranged onboard each of the fleet of vehicles, a set of one or more remote computing subsystems, and/or any combination of onboard and remote computing subsystems. Further additionally or alternatively, the computing subsystem can include and/or interface with computing subsystems onboard user devices (e.g., edge devices, tablets, laptops, mobile phones, etc.) and/or any other computing subsystems.

In a preferred set of variations, the computing subsystem includes an onboard computer arranged onboard each of a set of ego agents and a remote computing subsystem (e.g., cloud computing subsystem) in communication with the on-board computing computer, but can additionally or alternatively include a subset of these, other computing subsystems, and/or any combination.

The system further preferably includes and/or interfaces with a set of user interfaces, which can be provided to and/or accessed by any or all of: workers at a site (e.g., as described below), drivers of the vehicles (e.g., safety drivers), remote operators (e.g., teleoperators), fleet management entities, and/or any other entities. The user interfaces are preferably in the form of client applications executable on a device (e.g., user device, mobile device, tablet, laptop, computer, smartphone, etc.) or other suitable computing subsystem and/or any associated output devices (e.g., displays, speakers, etc.), but can additionally or alternatively include any other user interfaces.

The client can be a native application, a browser application, an operating system application, or be any other suitable application or executable.

In some variations, for instance, user interfaces are utilized by workers at a site (equivalently referred to herein as a customers, site workers, associates, etc.) and are configured to enable any or all of: optimize site worker interactions with vehicles in the fleet; optimize site worker interactions with other vehicles (e.g., vehicles outside the fleet, AVs, non-AVs, etc.); ensure load security (e.g., through an authorized access process implemented at the user interface for the fleet, ensure that the load is secure, ensure that only designated individuals interact with an AV, etc.); track load information before, during, and after a loading or unloading process; allow authorized users to control basic functions on the AV, communicate with the AV when it is safe to depart, call for assistance if needed, and/or otherwise interact with an AV; provide the AV with information (e.g., let the AV know it is safe to leave a dock and/or site, indicate to the AV why it is not yet safe to leave and/or why a delay has occurred, etc.); and/or convey any other information or actions.

Examples of the user device include a tablet, smartphone, mobile phone, laptop, watch, wearable device (e.g., glasses), or any other suitable user device. In some variations, for instance, site (e.g., yard) and/or depot workers can interact with user devices (e.g., tablets, computers, mobile phones, etc.) which function to enable the user to provide inputs to and/or receive information from a display or other output of the user device.

The user device can include power storage (e.g., a battery), processing systems (e.g., CPU, GPU, memory, etc.), user outputs (e.g., display, speaker, vibration mechanism, etc.), user inputs (e.g., a keyboard, touchscreen, microphone, etc.), a location system (e.g., a GPS system), sensors (e.g., optical sensors, such as light sensors and cameras, orientation sensors, such as accelerometers, gyroscopes, and altimeters, audio sensors, such as microphones, etc.), data communication system (e.g., a WiFi module, BLE, cellular module, etc.), or any other suitable component

Outputs of the user device can include any or all of: displays (e.g., LED display, OLED display, LCD, etc.), audio speakers, lights (e.g., LEDs), tactile outputs (e.g., a tixel system, vibratory motors, etc.), or any other suitable output.

Inputs of the user device can include any or all of: touch screens (e.g., capacitive, resistive, etc.), a mouse, a keyboard, a motion sensor, a microphone, a biometric input, a camera, or any other suitable inputs.

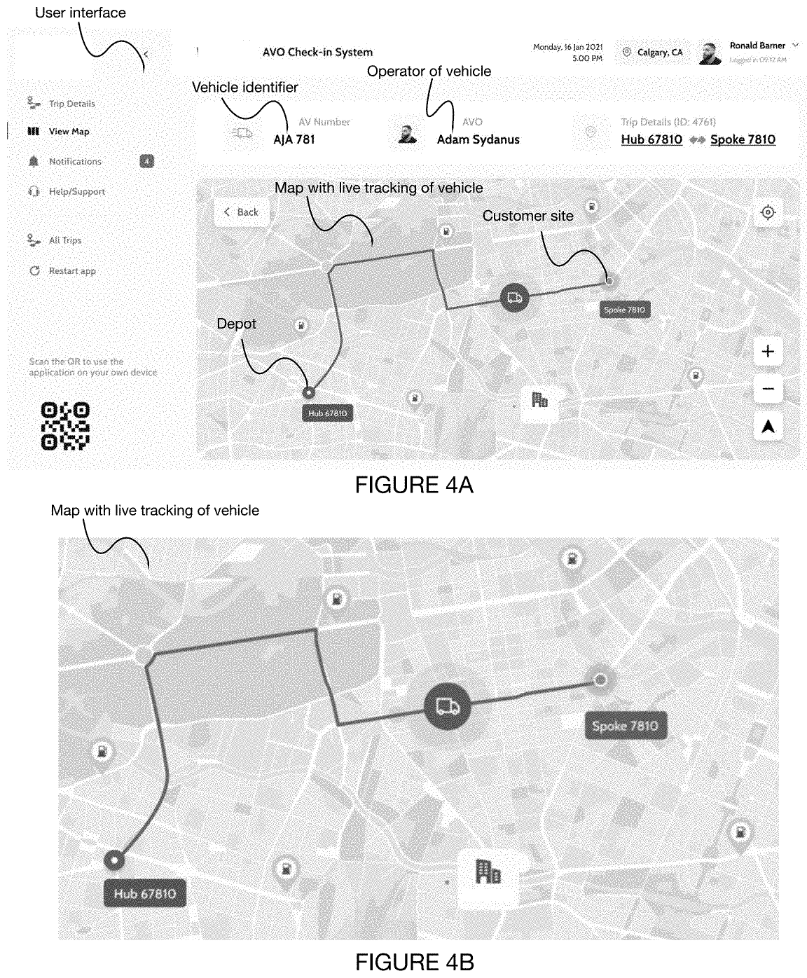

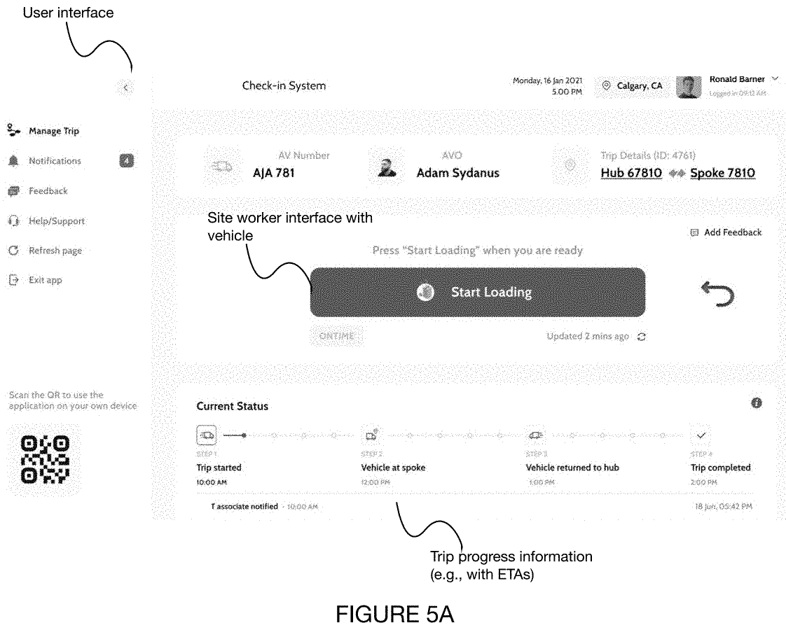

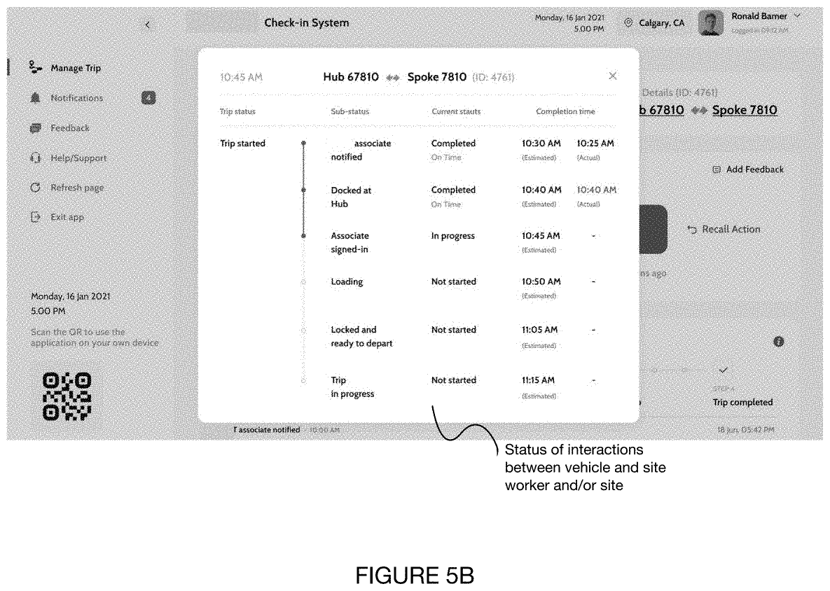

Examples of user interfaces are shown in FIGS. 4A-4B and FIGS. 5A-5B.

The system further preferably includes and/or interfaces with a set of sensors onboard the ego agent, such as, but not limited to, any or all of: sensors coupled to an exterior of the vehicle, sensors coupled to an interior of the vehicle, sensors of supplementary systems of the vehicle, diagnostic sensors associated with the vehicle (e.g., as part of an on-board diagnostics [OBD, OBD-I, OBD-II, etc.] subsystem, and/or any other sensors. Additionally or alternatively, the sensors can be offboard the ego agent (e.g., in an environment of the ego agent, at a site, onboard a user device, etc.) or otherwise suitably located.

Sensors can include, but are not limited to, any or all of: cameras (e.g., visual range, multispectral, hyperspectral, IR, stereoscopic, etc.), light detection and ranging (lidar) sensors, radio detection and ranging (radar) sensors, orientation sensors (e.g., accelerometers, gyroscopes, altimeters), acoustic sensors (e.g., microphones), optical sensors (e.g., photodiodes, etc.), temperature sensors, pressure sensors, flow sensors, vibration sensors, proximity sensors, chemical sensors, electromagnetic sensors, force sensors, sensors which are in communication with an OBD port or other Original Equipment Manufacturer (OEM) system, telematic sensors, and/or any other type(s) of sensors.

The system can optionally include and/or interface with a set of one or more communication subsystems, which can function to enable any or all of: communication between vehicles (e.g., vehicles of the fleet, a fleet vehicle and a non-fleet vehicle, etc.), communication between management subsystems (e.g., as described below), communication between a management subsystem and a vehicle, communication between a management subsystem and a user interface (UI), communication between a vehicle and a user interface, and/or any other types of communication.

The communication subsystem(s) can include one or more radios or any other suitable component(s). The communication subsystem can be a long-range communication system, a short-range communication system, or any other suitable communication system. The communication system can facilitate wired and/or wireless communication. Examples of the communication system include: 802.11x, Wi-Fi, Wi-Max, WLAN, NFC, RFID, Bluetooth, Bluetooth Low Energy, BLE long range, ZigBee, cellular telecommunications (e.g., 2G, 3G, 4G, LTE, etc.), radio (RF), microwave, IR, audio, optical, wired connection (e.g., USB), or any other suitable communication module or combination thereof.

The system preferably includes and/or interfaces with a set of one or management subsystems (e.g., software platforms, centralized software platforms, management software, etc.), which function to enable, orchestrate, coordinate, interface with, and/or trigger (e.g., initiate) any or all of the processes of the method 100. Additionally or alternatively, the set of management subsystems can function to enable operation of the set of vehicles (e.g., driving along a route) and/or perform any other functions.

The set of one or more management subsystems are preferably in communication with (e.g., part of, including, interfacing with, etc.) the set of computing subsystems, such that, for instance, actions of the management subsystems can be determined and/or triggered based on processing performed at and/or with the computing subsystems. In a preferred set of variations, for instance, the set of management subsystems are at least partially cloud-based (e.g., implemented at a remote computing subsystem). Additionally or alternatively, the set of management subsystems can interface with and/or include local computing subsystems (e.g., onboard computing subsystems, site-based computing subsystems, etc.) or combination of computing subsystems. The set of management subsystems can further interface with any or all of: user interfaces and/or user devices (e.g., to facilitate and initiate provision of notifications and/or alerts to users and/or vehicles), vehicles (e.g., fleet vehicles, non-fleet vehicles, etc.), databases (e.g., for use in fleet optimization, for use in aggregating data, etc.), and/or any other components.

The set of one or more management subsystems can interface with any number of users and/or teams of users, such as any or all of: teams associated with one or more customer sites (e.g., loading yards and/or docks and/or bays, customer parking lots, etc.), which can be referred to as any or all of customer operations teams, receiving teams, site/yard workers, and/or any other teams; teams associated with one or more fleet sites (e.g., workers arranged at a fleet depot at which fleet vehicles are stored and/or maintained [e.g., between trips to customer sites]); teams associated with operations of a fleet, which can be referred to as a fleet operations team (e.g., human drivers, fleet managers and/or schedulers, fleet maintenance and/or cleaning and/or repair teams, etc.); teleoperation teams; and/or any other teams and/or combination of teams.

A customer site preferably refers herein to a location and/or region (e.g., yard, lot, bay, plot of land, etc.) associated with a customer of a fleet, at which fleet vehicles— and optionally any number of non-fleet vehicles—receive and/or drop off goods (e.g., loads, shipments, etc.). These can include and/or be associated with, for instance, any or all of: retail stores, distribution centers, fulfillment and/or sorting centers (e.g., micro-fulfillment centers), storage centers, warehouses, manufacturing sites, homes, and/or any other locations. In a preferred set of use cases, for instance, fleet vehicles are utilized in autonomously and/or semi-autonomously transporting goods between customer sites (e.g., picking up from a 1^{st} set of customer sites and dropping off at a 2^{nd} set of customer sites). Additionally or alternatively, the fleet vehicles can be used in transporting passengers, transporting goods and/or passengers between any numbers and/or types of sites, and/or can be used in any other suitable way(s).

A fleet site preferably refers herein to a location and/or region (e.g., lot, yard, depot, etc.) at which a fleet vehicle is any or all of: stored (e.g., when not at a customer site and/or between customer sites, domiciled at night, etc.), maintained, repaired, re-fueled, and/or otherwise arranged at. Additionally or alternatively, non-fleet vehicles can interface with fleet sites, fleet vehicles can load and/or unload goods at fleet sites, fleet vehicles can be stored and/or maintained and/or repaired and/or re-fueled at customer sites and/or at other locations, the fleet vehicles can operate without fleet sites, and/or the fleet vehicles can otherwise be suitably operated.

Additionally or alternatively, the fleet vehicles can interact with any other suitable sites for any suitable functions.

The users can be human users, automated assistants and/or robots, and/or any combination of human and non-human users.

The set of management subsystems can individually or collectively function to perform and/or take part in any or all of: shipment scheduling, route planning and/or route optimization, vehicle monitoring (e.g., live fleet monitoring), data collection (e.g., for analysis, fleet optimization, site optimization, etc.), authentication and/or security of goods collection, site safety, vehicle acceptance and/or release, and/or any other functions.

The set of management subsystems can optionally include a fleet management subsystem (e.g., fleet management platform, fleet management software platform, etc.), which can function to perform (e.g., individually, collectively such as a collectively with a site management subsystem as described below, etc.), for instance, any or all of: shipment scheduling, route planning (e.g., high-level route planning, site ordering, etc.), dispatch scheduling and/or initiation, delivery and/or pick-up optimizations, live fleet monitoring, data collection and/or aggregation, overall fleet optimizations, vehicle-to-vehicle interactions, re-routing fleet vehicles (e.g., changing the order of sites that a fleet vehicle travels to in a day), and/or any other functions.

The fleet management subsystem preferably receives as input sensor data (e.g., camera data, lidar data, radar data, location data, etc.) from fleet vehicles, but can additionally or alternatively receive and/or collect any or all of: information (e.g., scheduling information, requests, notifications, etc.) from a site management subsystem (e.g., as described below), information from one or more databases (e.g., aggregated historical fleet data, traffic database data, weather database data, etc.), information from user devices and/or user interfaces, and/or any other information.

In a preferred set of variations, the fleet management subsystem is involved in shipment scheduling for fleet vehicles and/or executing shipment schedules (e.g., as received from a site management subsystem) for fleet vehicles. In a set of examples, for instance, based on high-level scheduling instructions (e.g., time and location a dock will be available) received from a site management subsystem, the fleet management subsystem can initiate, refine, optimize, and/or consolidate schedules for associated fleet vehicles. In variations, for instance, a high-level set of available times and locations associated with a customer site are provided to the fleet management subsystem (e.g., from a site management subsystem) and used by the fleet management subsystem to assign and manage the assignments of times and destinations to individual fleet vehicles (e.g., based on the schedules of other fleet vehicles, based on the availability of fleet vehicles, based on the other customer sites that a fleet vehicle needs to travel to, based on an optimization of the type and/or weight of goods a fleet vehicle can hold, based on fuel efficiency considerations, based on an optimized consolidation of shipments, etc.). In a set of examples, for instance, the fleet management subsystem receives high level scheduling information from a site management subsystem, consolidates the information and/or otherwise optimizes the schedules for individual vehicles, assigns the schedules to the vehicles, and creates a single source-of-truth schedule for the fleet. In a particular specific example, the fleet management subsystem can further adjust the schedules (e.g., adjust the order of sites that the fleet vehicles travel to, re-route a vehicle to a different location, change the timing of the loading and/or unloading of the fleet vehicle at a site, etc.) of fleet vehicles in response to any or all of the processes of the method 100, such as upon a determination (e.g., based on sensor data collected at a different fleet vehicle at that site) that that site is not currently available and/or not predicted to be available at the original time. This can optionally conflict, for instance, with the information associate with the site management subsystem, thereby enabling fleet vehicles to operate based on the most up-to-date, dynamically determined information. Additionally or alternatively, shipment scheduling can occur in any other suitable ways.

The fleet management subsystem can optionally additionally or alternatively perform live (e.g., real-time, near-real-time, substantially real-time, with a delay of less than 5 seconds, with a delay of less than 1 second, with a delay of less than 500 milliseconds, with a delay of less than 100 milliseconds, with a delay of less than 50 milliseconds, etc.) monitoring and/or data collection of the fleet vehicles, which can function to: provide sites with up-to-date information (e.g., current location, estimated time of arrival [ETA], information about the load being carried by the vehicle and/or the load to be picked up at the site, etc.) such that site workers can optimally (e.g., efficiently) prepare for arrival of vehicles, provide fleet management entities (e.g., the fleet management subsystem, depot workers, fleet maintenance team, etc.) with up-to-date information regarding the vehicle state (e.g., fuel levels, diagnostic trouble codes, tire pressures, engine temperatures, etc.) such that the vehicles can be efficiently and/or otherwise optimally serviced, optimize an efficiency of the overall fleet, enable an efficient re-routing of vehicles (e.g., based on accurate known locations and/or estimated time of arrivals) in an event that a delay or unexpected event occurs, and/or can perform any other function(s).

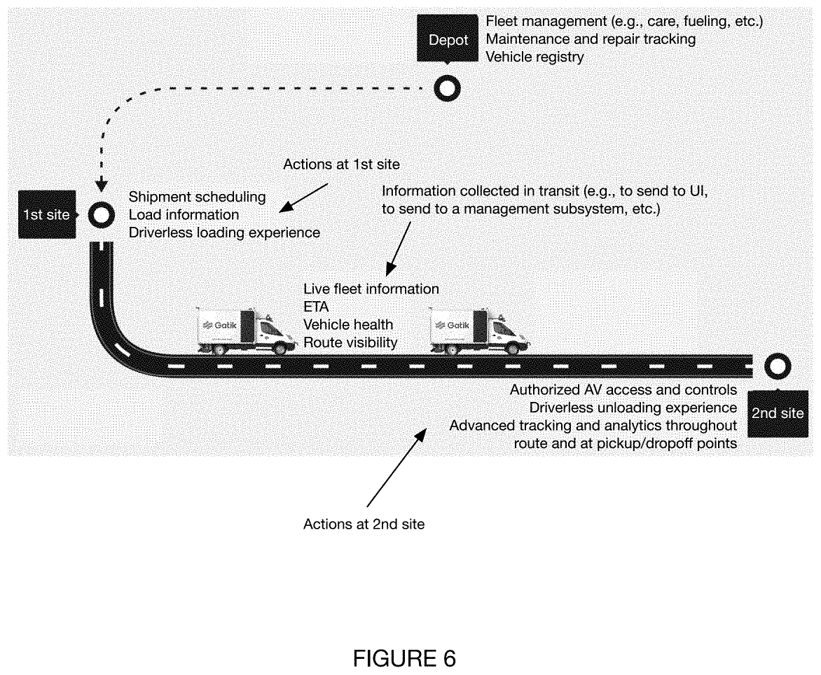

In a set of variations (e.g., as shown in FIG. 6), for instance, the fleet management subsystem collects location data throughout movement of the fleet vehicle (e.g., once it leaves a geofenced area such as a customer site and/or depot, if traversing to a customer site, any time it is moving, etc.), which can be processed to determine an ETA for the vehicle arriving at its destination (e.g., customer site, depot, maintenance location, etc.). In some examples, for instance, additional information (e.g., collected by vehicles, received from a database or 3rd party subsystem, etc.) can be used and/or processed (e.g., with the vehicle's location, independent of the vehicle's location, etc.) to determine a most accurate ETA for the vehicle, such as one determined based on and/or adjusted for any or all of: traffic conditions (e.g., as detected by other vehicles on the road, as received from a traffic database and/or map estimate, etc.), weather conditions (e.g., road conditions, predicted road conditions based on current and/or predicted weather, etc.), vehicle conditions (e.g., current fuel level, current maintenance condition, etc.), and/or any other conditions.

This supplementary information (e.g., traffic conditions, road conditions, etc.) can be any or all of: determined based on information collected from other vehicles (e.g., fleet vehicles, non-fleet vehicles, etc.) on the road (e.g., based on processed sensor data [e.g., camera data] from other fleet vehicles traversing a route), determined based on database and/or 3rd party information (e.g., traffic databases, traffic reports, map applications, live weather updates, etc.), predicted (e.g., based on aggregated and/or historical information, with a set of models such as a set of trained [e.g., machine learning, deep learning, etc.] models, etc.), received from users (e.g., site workers, depot workers, etc.), determined based on a combination of information, and/or determined in any other suitable ways.

In a set of examples (e.g., as shown in FIGS. 4A-4B), a user interface is provided to one or more users (e.g., customer site workers, depot workers, vehicle operators, etc.) which provides live monitoring of the vehicle's location and optionally additional information such as, but not limited to: an ETA for the vehicle arriving at its destination, a sub-destination of the vehicle (e.g., which loading dock and/or parking spot it is assigned to, etc.), a history of the vehicle's travels and/or health information (e.g., sensor information, diagnostic information, fuel levels, etc.), load information, and/or any other information.

The fleet management subsystem can optionally additionally or alternatively collect and/or process environmental information collected from the fleet vehicles (e.g., at a set of sensors), which can function to: maintain dynamic understandings of sites, enable more optimized scheduling to be performed for a fleet based on up-to-date information, increase the available types of information associated with a site (e.g., human locations), reduce idling times of vehicles at sites, prevent chaos and/or over-crowding at sites, improve a safety associated with a site, and/or perform any other functions.

In a preferred set of variations, for instance, dynamic data is collected from sensors of each fleet vehicle (e.g., at a site, on their way to a site, at a depot, etc.), which can be used to determine, create, and/or supplement a dynamic representation of that vehicle's environment, where the dynamic representation can be used for any or all of: optimizing and/or adjusting schedules and/or routes of other vehicles, facilitating order and/or minimizing congestion associated with a site, increasing the safety of vehicles and humans at a site, optimizing movements within a site (e.g., informing where vehicles should arrive and/or wait if a site is congested, informing trajectories of vehicles within a site, etc.), and/or performing any other functions.

The dynamic data is preferably collected from at least a set of optical sensors, such as a camera data and/or lidar data (e.g., from cameras and/or lidar sensors mounted to an interior and/or exterior of the vehicle), but can additionally or alternatively include radar data and/or any other sensor data. The sensor data can then be processed (e.g., with a set of models and/or algorithms [e.g., object detection models and/or algorithms, computer vision models and/or algorithms, etc.]) to determine any or all of: the presence of objects (e.g., vehicles, humans, inanimate objects, etc.), the locations of objects (e.g., relative to loading docks, relative to parking spots, etc.), the sizes of objects, parameters associated with objects (e.g., direction of movement, direction of potential movement, speed, turn signal indicator status of a vehicle, etc.), site information (e.g., number of loading docks, presence of waiting areas for vehicles and/or their occupancies, number of site workers present and their locations, etc.), site conditions (e.g., whether the ground surface is wet and/or slick, if the ground is icy, if there is snow present, if there are potholes or obstructions present, if there is a spilled load, etc.), whether or not an object is present that may be obstructed from another vehicle (e.g., in a vehicle's blind spot) such that this information can be utilized by that other vehicle, and/or any other information.

In a set of variations, vehicles of the fleet are configured and/or effectively act as mobile sensor units to collectively maintain a dynamic awareness of sites, such as customer sites and/or fleet-managed sites (e.g., depots). Additionally or alternatively, the fleet vehicles can monitor any other environments (e.g., roadways along routes, etc.).

In a preferred variation, for instance, as vehicles of the fleet complete their pick-ups and deliveries, they will naturally be situated at multiple, different sites throughout the day. As they collect sensor information throughout the day, dynamic environmental representations of the sites can be determined and maintained (e.g., as long as at least one vehicle is present at each site, as long as at least enough vehicles to collectively have a site-wide field of view are present at each site, etc.). This can have numerous advantages over conventional and/or current management subsystems, such as site management subsystems (e.g., as described below) and/or other management subsystems, which may: only determine a subset of this information (e.g., only locations of vehicles at loading docks), not dynamically update this information (e.g., rely on manual inputs from site workers and/or human drivers) leading to out-of-date information, and/or otherwise not include and/or provide accurate information. In set of examples of convention site management subsystems, for instance, the site management subsystem requires at least some manually entered data (e.g., from site workers, from drivers on non-AVs, etc.), which can cause lag issues, the propagation of inaccurate and/or infeasible schedules, long wait times for vehicles at the site, potential collisions or other unsafe conditions for vehicles at chaotic and/or over-crowded sites, and/or other outcomes.

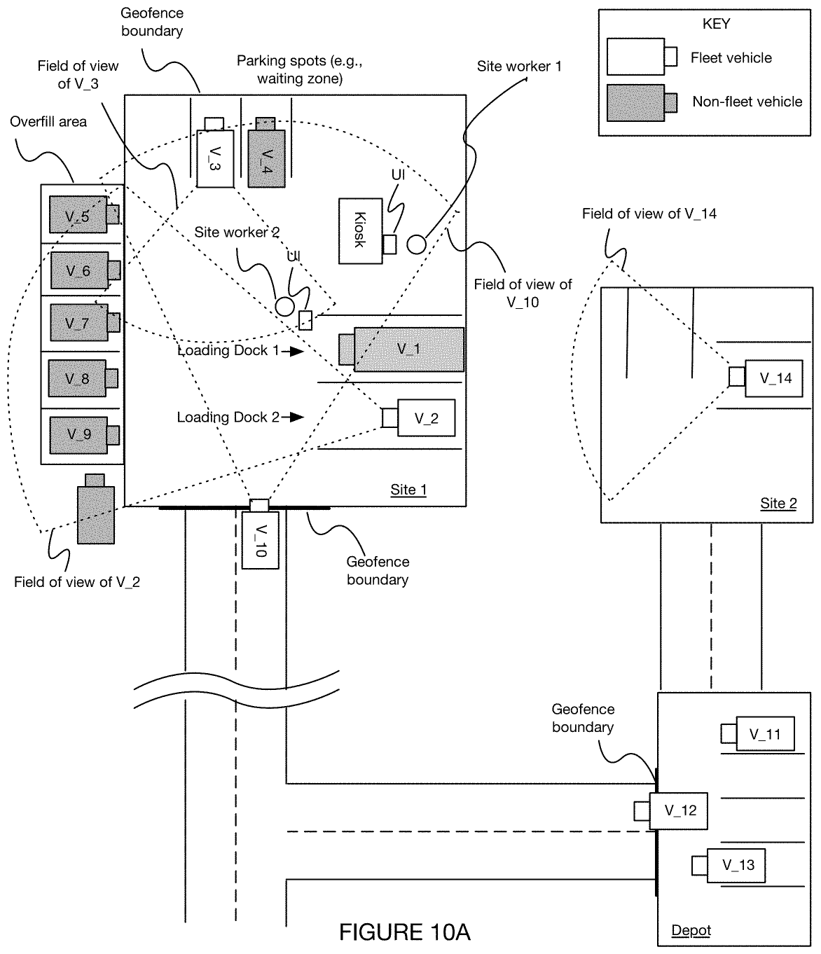

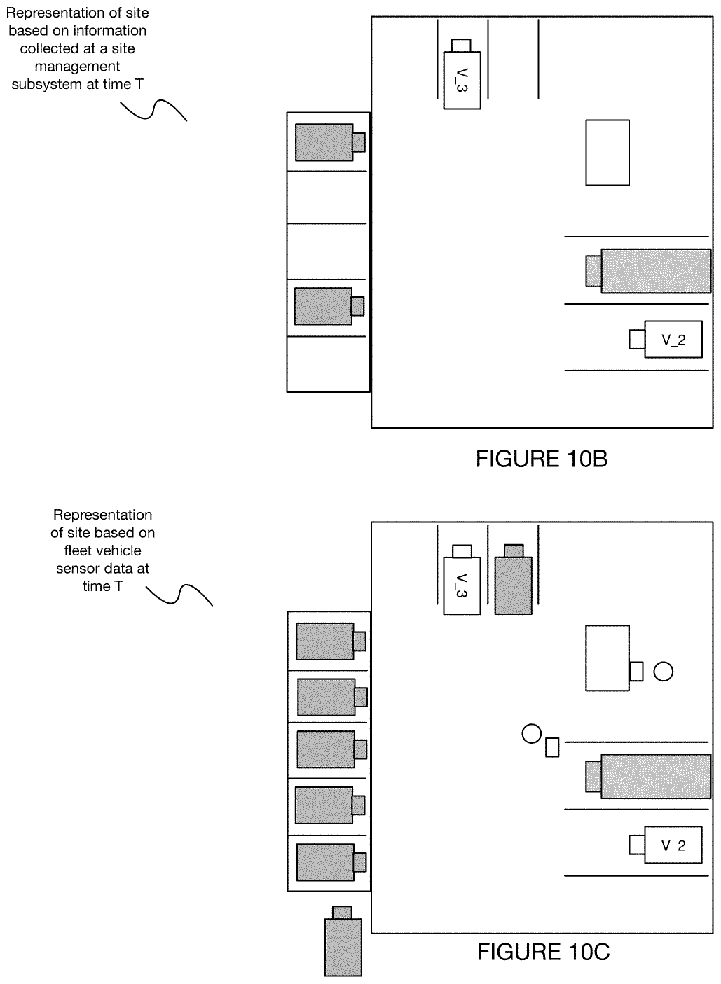

An example of a difference in an environmental representation produced based on information from vehicle sensors and that based on data collected at a site management subsystem is shown in FIGS. 10B and 10C, respectively.

Additionally or alternatively, fleet management subsystem can update and/or replace site management subsystem representations, representations can be combined and/or aggregated, a fleet management subsystem can be used in absence of a site management subsystem, and/or any other configuration of management subsystems can be implemented.

Outputs of the fleet management subsystem (and/or other management subsystems) can include, but are not limited to, any or all of: notifications (e.g., to site workers, to human drivers, to fleet operators, to teleoperators, etc.) or other alerts, information provided at user interfaces, environmental representations and/or environmental representation updates, automated scheduling, other triggered actions (e.g., as described below), and/or any other outputs.

Examples of outputs include, for instance: notifications provided to customer associates (e.g., site workers) with accurate vehicle ETAS to prepare for loading/unloading (see customer/site interfaces); notifications to users (e.g., customers) regarding delays and/or issues with delivery of a vehicle; notifications provided to other vehicles, fleet or non-fleet regarding updates and/or adjustments to schedules, conditions with a site, potential obstacles at a site, and/or any other information; the determination and/or adjustment of schedules and/or routes for vehicles to reduce idle time of vehicles, maximize fleet utilization, and/or other outcomes; the provision (e.g., to user interfaces) of visibility to users over an entire delivery network for a fleet; and/or any other outputs.

The set of management subsystems can optionally additionally or alternatively include and/or interface with one or more site management subsystems (e.g., for each site, for each customer, for multiple sites, etc.), which can function to: perform scheduling of vehicles (e.g., fleet vehicles, non-fleet vehicles, etc.) at a site, provide inputs to be used for scheduling (e.g., general loading dock and/or site availability), and/or be used in any other suitable ways.

The site management subsystem (equivalently referred to herein as a customer management subsystem) is preferably in communication with the fleet management subsystem, but can additionally or alternatively be: directly in communication with one or more vehicles (e.g., through a computing subsystem and/or control subsystem of the vehicle, with a driver of a vehicle through a user interface, etc.), directly in communication with one or more users (e.g., site workers, fleet operations team members, manual vehicle drivers, through user interfaces, etc.), absent of communication with a fleet management subsystem, and/or otherwise in communication or not in communication with other entities.

In a first set of variations, the fleet management subsystem integrates with a site management subsystem of each customer and/or each site of each customer.

In a second set of variations, each customer integrated with the fleet management subsystem of the set of vehicles.

Examples of site management subsystems include, but are not limited to, any or all of: transport management systems (TMS), warehouse management systems (WMS), yard management systems (YMS), Enterprise Resource Planning (ERP) systems, any other software platforms, and/or any combination of software platforms.

Information from the site management subsystems can include, but is not limited to, any or all of: scheduling information (e.g., appointment times, where a load should and/or needs to be dropped off, when a load should and/or needs to be dropped off, what type of load needs to be received, etc.), dock availability and/or an assigned dock (e.g., planned and/or current status of dock doors being occupied or unoccupied), and/or any other information.

In a set of variations, for instance, the site management subsystem provides scheduling information to the fleet management subsystem, such as any or all of: a set of appointment times for fleet vehicles and a set of locations (e.g., dock door assignments) for the fleet vehicles to load and/or unload. Additionally or alternatively, any other information can be provided and/or the information can be provided to any other entities (e.g., site workers through user interfaces, vehicles directly, fleet vehicles, non-fleet vehicles, etc.).

In a set of examples, the fleet management subsystem collects, determines, and/or supplements this information with any or all of: information (e.g., presence, locations, etc.) about non-vehicular objects (e.g., pedestrian locations such as detection that a human is arranged within a loading dock), information about non-fleet vehicles (e.g., which has not been and/or not yet been manually entered into the site management subsystem), information about non-docking and/or non-site areas (e.g., occupancy of parking lots, waiting areas, roadways leading into site, etc.; detection that a traffic jam is leading into the site; detection that there are “x” number of vehicles waiting to get into the site and/or a dock; etc.), and/or any other information.

Additionally or alternatively, the site management subsystem can receive and/or provide any or all of this information and/or the information described above.

Further additionally or alternatively, the system can include and/or interface with other management subsystems, the management subsystems can have other functionalities, functionalities of fleet management subsystem can performed by other and/or multiple management subsystems, functionalities of the site management subsystem can be performed by other and/or multiple management subsystems, and/or the management subsystems can be otherwise configured.

Additionally or alternatively, the system can include and/or interface with any other suitable components.

### 4. Method

As shown in FIG. 1, a method 100 for operation of fleet vehicles includes collecting a set of inputs S110; processing the set of inputs to determine a set of actions associated with a vehicle and/or a site S120; and triggering the set of actions S130. Additionally or alternatively, the method 100 can include aggregating any or all of the set of inputs S115, and/or any other suitable processes. Further additionally or alternatively, the method 100 can include and/or interface with any or all of the methods, processes, embodiments, and/or examples for operating the ego agent as described in any or all of: U.S. application Ser. No. 17/116,810, filed 9 Dec. 2020; U.S. application Ser. No. 17/125,668, filed 17 Dec. 2020; and U.S. application Ser. No. 17/127,599, filed 18 Dec. 2020; each of which is incorporated herein in its entirety by this reference.

The method 100 is preferably performed with a system 200 as described above, but can additionally or alternatively be performed with any other suitable system(s).

The method 100 functions to optimize the interaction between a set of vehicles (e.g., fleet vehicles, non-fleet vehicles, etc.) and a site, which can include any or all of: increasing a speed and/or efficiency with which vehicles are able to load and/or unload materials, decreasing congestion of vehicles at a site, managing multiple vehicles at a site, optimizing the schedule and/or route of a vehicle and/or fleet of vehicles based on conditions associated with one or more sites (e.g., diverting an ego agent from a site which is congested and/or delayed) and/or conditions leading into one or more sites, updating and/or maintaining a dynamic representation of a site to be utilized by and/or propagated to other entities (e.g., other fleet vehicles, non-fleet vehicles, users, etc.), and/or optimizing for any other parameters or use cases.

### 4.1 Method—Collecting a Set of Inputs S110

The method 100 includes receiving a set of inputs S210, which functions to receive information with which to assess a set of one or more sites associated with the ego agent(s). This can be used in subsequent processes of the method to determine schedules for a fleet of vehicles, optimize an operation of one or more fleet vehicles, optimize one or more processes at a site, and/or otherwise improve the management of a fleet and/or site.

The set of inputs is preferably at least partially collected at and/or received from a set of fleet vehicles (equivalently referred to herein as ego agents), but can additionally or alternatively be received from non-fleet vehicles (e.g., via user interfaces associated with drivers of the vehicles, via management subsystems associated with those vehicles, etc.). Inputs can additionally or alternatively be received from any or all of: a set of devices (e.g., mobile device of a driver and/or safety driver, device of a teleoperator, device of a worker at the site, devices and/or systems onboard the ego agent, etc.), a set of user interfaces (e.g., client applications executing on a mobile device), 3rd party information sources, any number of management subsystems (e.g., site management subsystems, fleet management subsystems, etc.), and/or any other information sources.

The set of inputs preferably includes sensor data (e.g., telematic information, camera data, lidar data, etc.) associated with the set of ego agents. In some variations, for instance, at least a portion of the sensor data is in the form of telematic information is received from Original Equipment Manufacturer (OEM) components of the ego agent, such as through an On-Board Diagnostics (OBD) port (e.g., OBD-ii port, Wifi OBD port, etc.) (e.g., location information), and another portion of the sensor data is optical data (e.g., camera data, lidar data, etc.) or other data (e.g., location data collected at a GPS sensor) collected at a sensor stack of the vehicle. Additionally or alternatively, other types of sensor data can be received from any other components.

The sensor data (e.g., telematic information) can include and/or be used to determine (e.g., derive, calculate, etc.) any or all of the following information associated with any or all of the set of ego agents: location information (e.g., real-time tracking of vehicle's location, location at which vehicle spends most time idling, etc.), speed, gear shift information (e.g., which gear shift(s) the vehicle was operating in, which gear shift changes the vehicle experienced, etc.), idling time of the vehicle (e.g., time that the vehicle has spent idling at a loading/unloading site, ratio of time spent idling to time spent moving, etc.), acceleration information (e.g., magnitude of acceleration, changes in acceleration, maximum acceleration, maximum deceleration, etc.), braking information (e.g., magnitude of braking, changes in braking, time associated with reaching a full stop while braking, maximum braking, etc.), fuel information (e.g., fuel consumption, fuel level, etc.), maintenance information (e.g., time since last maintenance, types of maintenance performed on the vehicle, etc.), environmental information (e.g., what objects are in the vehicle's surroundings and where, how crowded a site is, where vehicles are located at a site, etc.), and/or any other information.

The sensor data can additionally or alternatively include a set of sensor inputs received from a sensor stack (e.g., non-OEM sensor stack) of the vehicle, which can include, for instance, any or all of: cameras (e.g., 360-degree coverage cameras, ultra-high resolution cameras, etc.), light detection and ranging (LiDAR) sensors, radio detection and ranging (RADAR) sensors, motion sensors (e.g., accelerometers, gyroscopes, inertial measurement units [IMUs], speedometers, etc.), location sensors (e.g., Global Navigation Satellite System [GNSS] sensors, Inertial Navigation System [INS] sensors, Global Positioning System [GPS] sensors, any combination, etc.), ultrasonic sensors, and/or any suitable sensors.

In some variations, for instance, the set of sensor inputs includes sensor streams from at least a set of cameras and/or lidar sensors which can be used to determine one or more features associated with a site. These features can include, for instance, a number of other ego agents detected at the site, a total number of loading and/or unloading locations (e.g., loading docks, loading dock spots, etc.), a total number of available (e.g., unoccupied) loading/unloading locations, a number of workers at the site, a number of available workers at the site, a number and/or type of vehicles (e.g., class of truck, size of truck, variety of trucks, etc.) at the site, a size of the site, locations of any or all of these objects, a congestion level of the site (e.g., number of available waiting areas/spots), and/or any other information.

In a set of specific examples, sensor inputs (e.g., from a set of cameras and/or LIDARs arranged onboard the ego agent) are processed with a set of computer vision algorithms/models to determine how crowded/busy the site is and/or an availability associated with the site to receive one or more ego agents, which can then be used to determine and trigger a set of actions (e.g., as described below). This can be determined based on any or all of: a number of vehicles at the site, a number of workers at the site, a number of available loading/unloading spots at the site, a number of available waiting spots at the site, and/or any other information.

In another set of specific examples, sensor inputs (e.g., from a set of cameras and/or lidars arranged onboard the ego agent) are processed (e.g., with a set of computer vision algorithms/models, with other algorithms/models, etc.) and compared with a set of safety codes associated with the site, wherein in an event that a safety code is detected to be breached and/or close to breached, one or more actions can be determined and triggered in S230.

The set of inputs can optionally include and/or be used to determine (e.g., derive, calculate, etc.) information associated with supplementary systems (e.g., retrofitted systems) and/or features of the ego agent, such as supplementary systems configured for the particular use case of loading and unloading goods from an autonomous vehicle (e.g., providing selective access to the vehicle, automatically or partially automatically loading and unloading goods, etc.). In some variations, for instance, this set of inputs includes information associated with robotic systems of the ego agent (e.g., for automated loading and/or unloading), door information of the ego agent (e.g., lock status of doors configured for automated closing and opening), lift gate information of the ego agent (e.g., lift status of automated lift gate, lift height of automated lift gate, etc.), inventory information, and/or any other information.

The set of inputs can optionally include and/or be used to determine (e.g., derive, calculate, etc.) information associated with operators (e.g., drivers, safety drivers, teleoperators, etc.) associated with the ego agent. This can include, for instance, any or all of: an identifier associated with a driver and/or teleoperator operating the ego agent; disengagement information associated with the driver and/or teleoperator; and/or any other information. In specific examples in which a driver (e.g., safety driver, manual driver, etc.) is present onboard the ego agent, information associated with the driver (e.g., an identify of the driver, behavior of the driver, rating of the driver, etc.) can be collected and/or exchanged via a user interface (e.g., application programming interface [API] associated with a client application executing on a device [e.g., mobile device, device fixed to ego agent, etc.]) associated with the driver and in communication with a remote computing system. The API can further enable the client application of the driver to communicate with a client application of a worker at the site (e.g., via a site management subsystem, directly, etc.) and/or facilitate any other communication.

The set of inputs can optionally include and/or be used to determine (e.g., derive, calculate, etc.) information associated with workers of the site, such as workers who facilitate loading and unloading, facilitate the movement of vehicles within the site, and/or monitor or perform any other tasks. This can include information detected based on sensors of the ego agent (e.g., a number of workers present at the site based on video streams collected at cameras of the ego agent), information directly received from the worker (e.g., as described below, received at a client application associated with the worker and/or the site, etc.), and/or any other inputs. In specific examples, the system can enable the ego agent to request authentication of a worker prior to triggering one or more actions in S230, such as unlocking the ego agent, operating the lift gate, initiating loading and/or unloading of the ego agent, and/or any other actions.

S110 can additionally or alternatively include receiving any other inputs and/or performing any other processes.

In a first set of variations, data collected in S110 includes any or all of: sensor data from a set of fleet vehicles, the sensor data including a first subset of sensor data collected from vehicles arranged at sites and/or proximal to sites (e.g., sensor data that identifies that a vehicle has passed a geofence associated with a site, optical data to visually assess and/or characterize the site, location of that vehicle within the site, etc.) and a second subset of sensor data collected from vehicles not arranged at a customer site (e.g., between sites, in transit to a site, at a depot, etc.) (e.g., location information, derived data such as an ETA, detection that the vehicle has crossed a geofence defining departure from a depot or site, etc.); scheduling information from a site management subsystem (e.g., assigned locations and/or time slots for vehicles of the fleet); information from user interfaces (e.g., of site workers, of fleet operators, of non-fleet vehicles, etc.); 3^{rd} party information (e.g., traffic data, weather data, etc.); and/or any other information.

In a set of specific examples (e.g., as shown in FIG. 10A), the first subset of sensor data includes optical data from fields of view of optical sensors of vehicles at the site, which can be used, for instance, to construct an environmental representation of the site in S120 (refer to figure).

4.2 Method—Aggregating and/or Pre-Processing the Set of Inputs S115

The method 100 can optionally include aggregating any or all of the set of inputs S115, which can function to determine actionable analytics with which to perform any or all of the remaining processes of the method 100. Additionally or alternatively, S220 can function to reduce the latency associated with transmitting a large volume of information, reduce the computational load of processing the set of inputs in S230, and/or perform any other suitable functions.

Aggregating the set of inputs can include aggregating the various inputs from the ego agent before being further processed in S120.

Aggregating the set of inputs can additionally or alternatively include aggregating optical data from multiple ego agents at a site such that an environmental representation can be constructed.

Aggregating the set of inputs can additionally or alternatively include aggregating data from multiple management subsystems to determine schedules for fleet vehicles.

Additionally or alternatively, Silo can include any other processes.

In a preferred set of variations S115 includes collecting sensor data from a set of sensors onboard the ego agent; with an onboard computing system and a set of algorithms and/or models, processing the sensor data to determine high level insights (as transmitting the raw sensor data would be too large of a data packet leading to high computational requirements and/or latency), the high level insights equivalently referred to herein as a first layer of lean data; combining the first layer of lean data with the telematic information (e.g., OEM data) and/or other sensor data; and transmitting this combined data to a remote computing system through a modem/router of the ego agent for processing in S120.

S115 can optionally additionally or alternatively include aggregating inputs from multiple sources (e.g., ego agent inputs with site inputs, ego agent inputs with teleoperator inputs, etc.) and/or any other processes.

4.3 Method—Processing the Set of Inputs to Determine a Set of Actions Associated with an Ego Agent and/or a Site S120

The method 100 can include processing the set of inputs to determine a set of actions associated with an ego agent and/or a site S120, which functions to determine which actions will optimize an operation of the ego agents and/or the site at which the ego agents are operating. Additionally or alternatively, S120 can function to determine actions operable to increase a safety associated with a site (e.g., prevent collisions due to congestion of sites, prevent collisions due to unidentified objects being present in blind spots of vehicles, etc.), and/or can perform any other functions.

The set of inputs and/or the aggregated set of inputs are preferably at least partially processed at a computing subsystem, and further preferably a remote computing subsystem (e.g., cloud computing subsystem, remote computing subsystem in communication with and/or hosting a fleet management subsystem, etc.), which processes the inputs with a set of algorithms and/or models and/or other tools (e.g., decision trees, lookup tables, rule-based models, logic, etc.). The outputs of this processing can then be used to determine and trigger one or more actions at any or all of: the ego agent and/or its supplementary systems, another ego agent in the fleet, the site (e.g., through a client application executing on a mobile device of a worker at the site), a teleoperator device, and/or at any other components and/or users.

Additionally or alternatively, S120 can be performed with onboard and/or local computing subsystems, a combination of computing subsystems, and/or with any other components.

The set of algorithms and/or models can include, but are not limited to, any or all of: trained algorithms and/or models (e.g., machine learning models, deep learning models, neural networks, etc.), programmed and/or rule-based algorithms, and/or any combination. Additionally or alternatively, the set of inputs can be processed with decision trees, lookup tables, and/or any other tools.

In some variations, a first set of algorithms is used to process the data from the ego agents (e.g., from Silo, from S115), and a second set of algorithms processes data received from applications (e.g., client applications executing on user devices associated with workers at the site), such that the insights from these sets of algorithms can be used to trigger actions and/or communicate information between the ego agent and the site (e.g., directly, via a site management subsystem, via a fleet management subsystem, etc.). Additionally or alternatively, actions can be triggered and/or communicated between vehicles, between users at the site, between the site and an operator (e.g., operator of the fleet vehicle, teleoperator of the fleet vehicle, operator of a non-fleet vehicle, etc.), between an operator and a vehicle, and/or any between any other entities.

Additionally or alternatively, the information can be otherwise processed and/or processed at any other suitable locations, with any suitable components, and/or optionally in combination with any suitable management subsystems and/or other software platforms.

Actions can include, for instance, but are not limited to, any or all of: transmitting information (e.g., through notifications, alerts, visual displays, audio alerts, etc.) to any suitable endpoints (e.g., vehicles, user interfaces, users, user devices, management subsystems, etc.); generating and/or updating (e.g., dynamically, in real-time, etc.) an environmental representation (e.g., map) of a current state of a site or other region; updating information of a management subsystem and/or its outputs (e.g., schedules, notifications to vehicles and/or drivers, etc.) based on the collected data (e.g., sensor data) and/or processed sensor data; triggering notifications and/or transmissions of information (e.g., triggering a notification and/or visual display at a customer interface upon vehicle passing through a geofence of its current site along with updated locations as it travels to the new site, triggering a notification to the vehicle and/or fleet management subsystem from the customer interface in response to the customer indicating that the loading/unloading process has been completed and/or that the vehicle is ready to depart, etc.); triggering a set of checks for the site worker (equivalently referred to herein as a customer) and/or vehicle to perform prior to the vehicle leaving the site (e.g., ensuring that the load has been unloaded, ensuring that the doors are secured, ensuring that the vehicle has checked its surroundings, etc.); triggering an authentication process of the site worker prior to providing the site worker with access to the vehicle load (e.g., automatically/autonomously unlocking the vehicle door); triggering a set of vehicle-to-vehicle communications (e.g., upon a first vehicle detecting that an object may be located in a second vehicle's blind spot, through the fleet management subsystem, through a dynamically updated environmental representation, involving the current availability of docks and/or waiting areas, involving potential obstacles and/or locations of humans within the site, involving weather conditions of the site, indicating that another vehicle that has yet to reach the site and/or arrive at the site should re-route to another site, etc.); controlling and/or updating control of a fleet vehicle based on the sensor data and/or processed sensor data and/or dynamic environmental representation (e.g., updating a schedule of a fleet vehicle, updating an order of site locations for a fleet vehicle to traverse to, updating a waiting location for a fleet vehicle at a congested site, etc.); and/or any number of other actions.

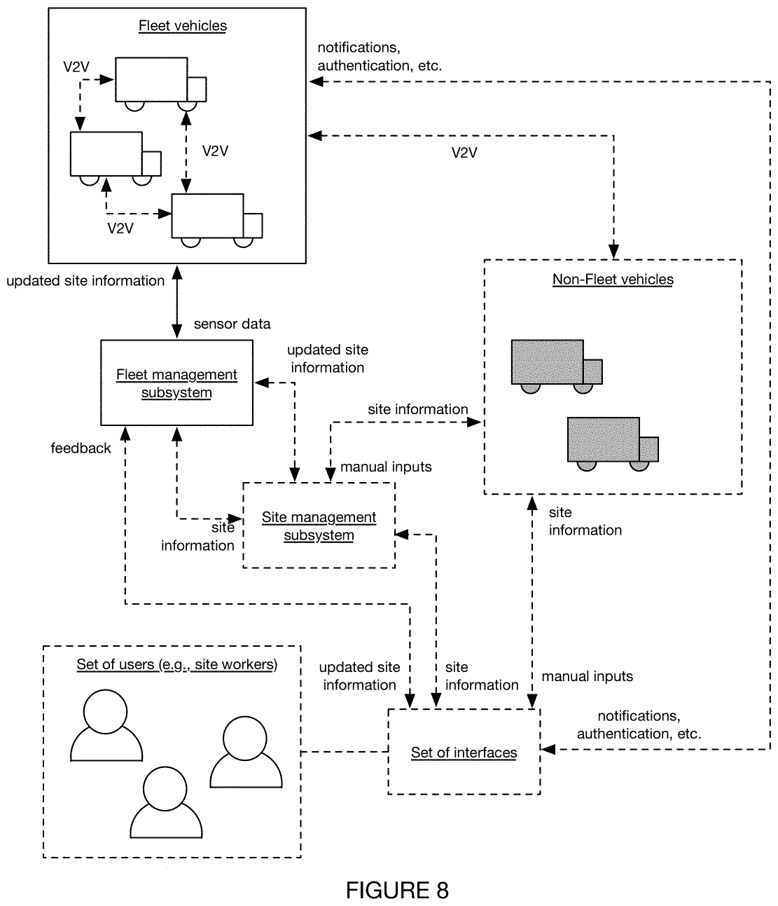

Examples of information exchanged between vehicles and/or users and/or components of the system are shown in FIG. 8.

In a first set of variations, S220 includes detecting that an ego agent has reached and/or passed a geofence associated with the site, wherein this detection can be used to determine and trigger an action of notifying workers at the site (e.g., via a client application executing on a tablet device of the worker) that the ego agent has arrived and/or will soon arrive (e.g., with an estimated time) at the site. This can function to help the worker prepare for the ego agent by clearing a space at the loading dock, by assigning a location at the site to the incoming ego agent, by ensuring that a worker is present and/or available to facilitate loading and/or unloading of the ego agent, and/or through any other actions.

Notifying the site and/or workers of the site can further prompt a set of inputs to be received from the worker, such as, but not limited to, any or all of: a location assignment (e.g., particular parking spot, particular loading dock, waiting area, etc.) for the ego agent, an estimated time until the ego agent can be loaded and/or unloaded (e.g., wherein in an event that this time exceeds a threshold, the ego agent can be diverted to another site first), and/or any other information.

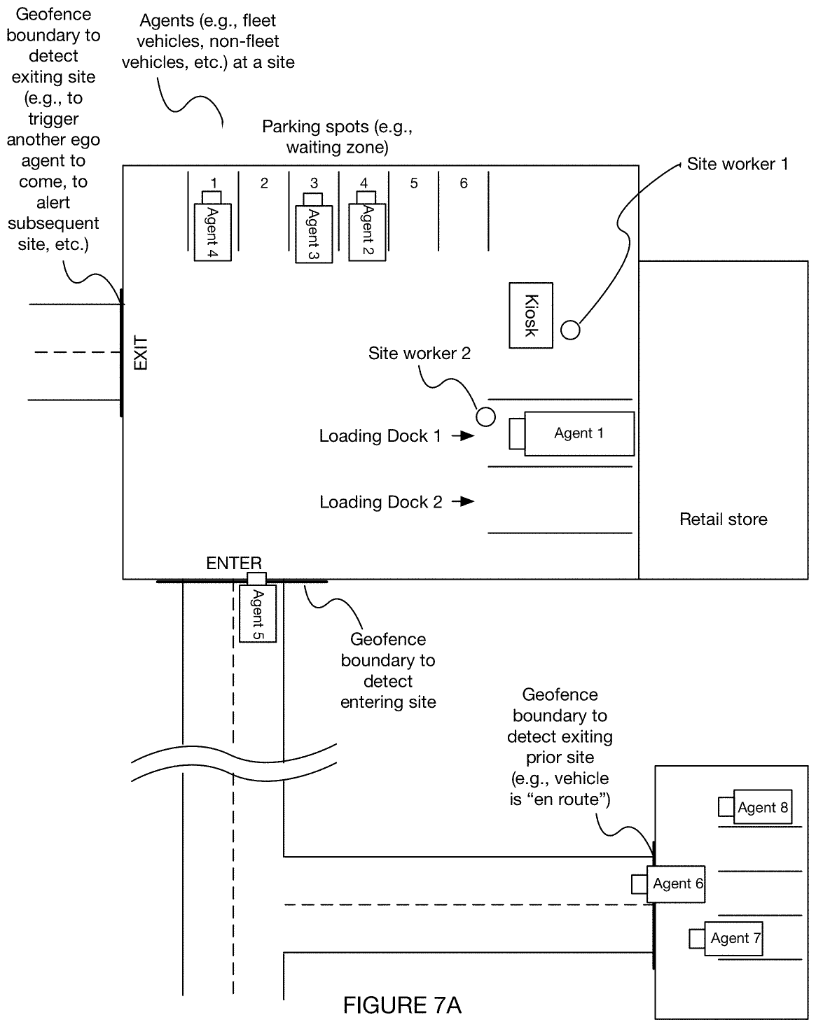

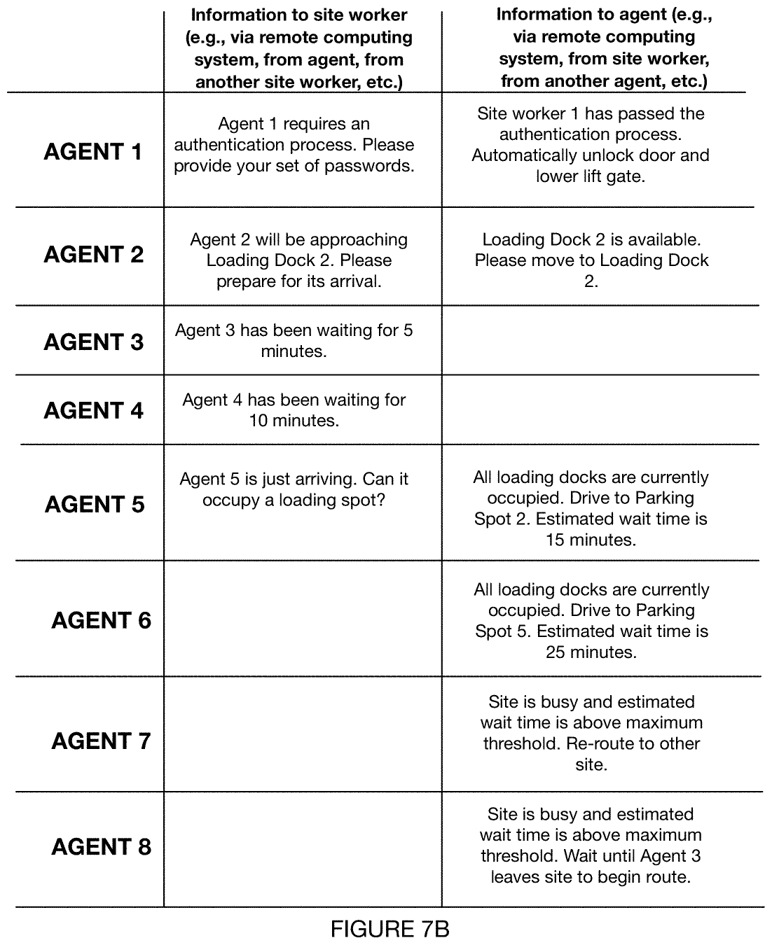

In a set examples, for instance, a detection that the ego agent has passed a geofence (e.g., based on telematic information, based on sensor information, based on aggregated telematic and sensor information, as shown in FIG. 7A, as shown in FIG. 10A, etc.) corresponding to a border of the site can trigger a notification at a user interface (e.g., client application) of a user device (e.g., tablet, laptop, smartphone, etc.) of a worker at the site, such that the worker can facilitate the ego agent's arrival and/or communicate information to the ego agent such that the ego agent can follow instructions from the worker for where to park and/or whether or not the site is ready for the vehicle to be loaded and/or unloaded. Additionally or alternatively, the geofence can be located at a previous site of the ego agent (e.g., to tell the second site that the ego agent has left the first site), along a route of the ego agent, and/or at any other locations.

In a specific example of the set, as the ego agent is arriving at the site, a notification can be sent to the worker and/or processed (e.g., with a predictive algorithm), which asks if the ego agent can occupy an active loading spot of the site. The worker and/or algorithm can then reply with instructions to either occupy the receiving spot or to occupy a temporary spot until they send a notification that they are ready to receive the ego agent.

In a second set of variations, S220 include detecting that an ego agent has breached a geofence associated with a fixed route of the ego agent, which can potentially indicate any or all of: that the vehicle has encountered an emergency and has had to divert from the fixed route (e.g., which can trigger teleoperation of the vehicle), that a safety driver onboard the ego agent has nefarious intentions and may be stealing the load of a newly loaded vehicle (e.g., which can trigger an alarm system), and/or any other scenarios.

In a third set of variations, S220 includes detecting that the ego agent has parked at the site (e.g., based on location information and a zero speed of the ego agent, based on cameras and/or LIDAR sensors of the ego agent, etc.), and in response, automatically notifying a worker at the site that the ego agent has arrived and the location (e.g., coordinates, particular parking spot number, etc.) at which the ego agent has parked. In use cases in which the ego agent is unmanned (and therefore a human cannot communicate this information directly to the worker at the site) and/or when the site is busy with a large number of ego agents, this can be useful in helping the site worker prioritize and deal with the ego agents in a timely manner.

In a fourth set of variations, S220 includes detecting (e.g., based on sensors of the ego agent, based on input from a client application of the worker, etc.) that a worker (e.g., human worker, robotic worker, etc.) is ready to load and/or unload the ego agent, which can trigger an unlocking of the ego agent, a movement of lift gates of the ego agent, an initiation of a robotic loading and/or unloading process, and/or any other actions. In response the client application can trigger an authentication process of the worker (e.g., verifying the worker's identity, verifying that the correct worker is present, etc.), wherein in response to the authentication, the ego agent provides access to the ego agent and/or its load. In a set of specific examples, for instance, an authentication process is performed at the back end, where the worker has a client application at a device/kiosk which requests a set of passwords and/or other forms of authentication from the worker. In response to the authentication requests, the back end authenticates the worker and can trigger any or all of the described actions at the ego agent. In another set of specific examples, it can be detected that a worker who started the unloading process has left before it has finished (e.g., to attend to another vehicle), and in response, can trigger the closing of the lift gate and/or shutting/locking of vehicle doors so that the goods of the vehicle are not stolen or exposed to the elements (e.g., heat in an event of frozen goods).

In a fifth set of variations, S220 includes detecting a breach of a safety code based on sensor inputs (e.g., as described above) and/or an environmental representation, which can then trigger any or all of: contacting a manager of the site, contacting a safety and/or regulatory agency associated with the site, re-routing ego agents currently en route to the site, and/or any other actions.

In a sixth set of variations, S220 includes detecting a potential danger and/or obstacle associated with the site, which can trigger a notification to a manager and/or worker of the site. In a set of specific examples, for instance, an ego agent can detect with its cameras that there is ice covering part of the road at the site, which could result in a collision between vehicles. As such, a notification can be automatically sent to the site to inform of the danger and prompt them to remedy.

In a seventh set of variations, S220 includes detecting, based on a first set of one or more ego agents at the site (e.g., based on sensor data collected at the ego agents, based on an updated environmental representation, etc.), that the site is busy and/or has limited availability, and in response, re-routing a second ego agent to another site such that the second ego agent can avoid the crowded site and come back once there is greater availability.

An example set of detections and/or triggered actions are shown in FIGS. 7A-7B.

Additionally or alternatively, S220 can include any other suitable processes.

### 4.4 Method—Triggering the Set of Actions S130

The method 100 can include triggering the set of actions S130, which functions to implement one or more actions which improve and/or optimize an operation of the ego agents and/or the site.

The actions can include (e.g., described above) any or all of: transmitting a notification and/or other information to the site (e.g., a worker of the site, a manager of the site, etc.); transmitting instructions to an onboard computing system of the ego agent (e.g., which prompts a re-routing of a second ego agent, which prompts a location for the ego agent to occupy, which prompts a trajectory to be determined for the ego agent, etc.); operating (e.g., automatically operating) any or all of the supplementary systems of the ego agent (e.g., unlocking the ego agent, locking the ego agent, actuating the lift gate, initiating robotic unloading of the ego agent, initiating robotic loading of the ego agent, etc.); and/or any other actions.

The actions can be triggered at any or all of: computing subsystems, site management subsystems, user interfaces, user devices, vehicle control subsystems, vehicle communication subsystems, and/or at any other components of the system and/or components independent of the system.

Additionally or alternatively, S130 can include any other suitable processes.

In a first demonstrative example of the method 100 (e.g., as shown in FIGS. 8A-8B), various information exchanged between vehicles and site workers (e.g., via user interfaces, via management subsystems, etc.) can be used to optimize the loading and/or unloading of vehicle loads.

Additionally or alternatively, communications can be had between vehicles (e.g., between fleet vehicles, between fleet vehicles and non-fleet vehicles, via management subsystems, etc.), between management subsystems, between any permutations or combinations of entities, and/or any other actions can be triggered.

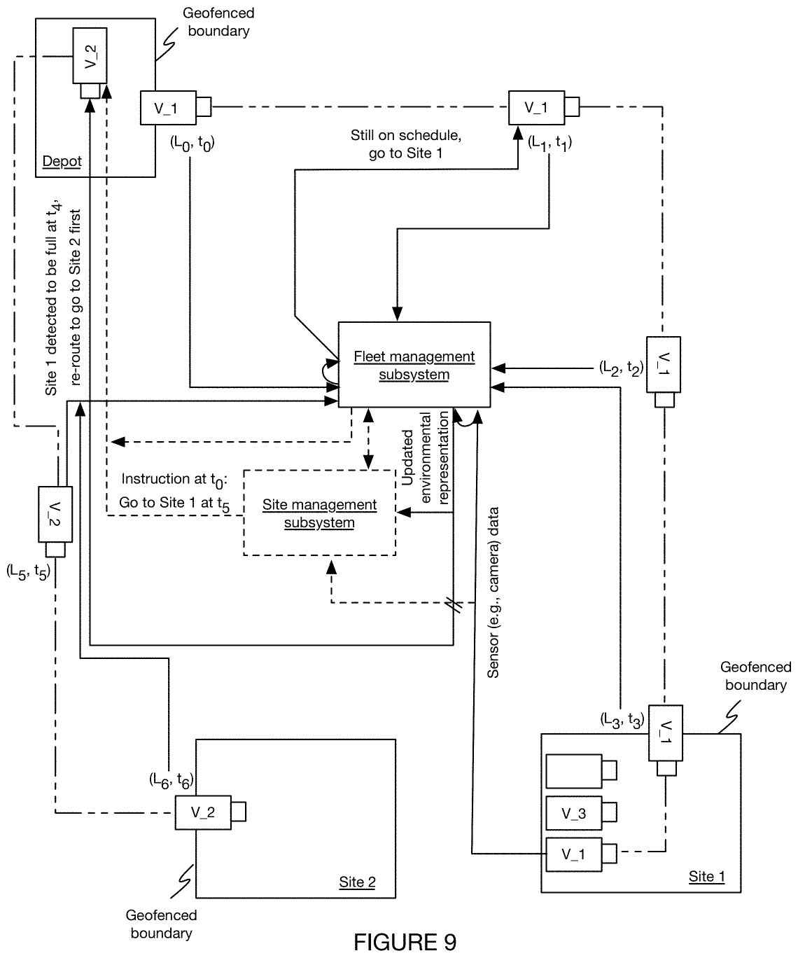

In a second demonstrative example of the method 100 (e.g., as shown in FIG. 9), in addition or alternative to the first, data (e.g., sensor data) is collected and actions are triggered which update the schedules and/or routes of vehicles based on updated information collected by vehicles arranged at the sites in question. As shown in FIG. 9, for instance, information collected by one or more vehicles at a first site (e.g., V_1, V_1 and V_3, etc.) and/or an associated environmental representation created based on the information can be used to identify that the first site is fully occupied (e.g., which can be in contrast with an understanding of a site management subsystem, which can be used to update the understanding of a site management subsystem, etc.), which can in turn be used to re-route another vehicle (e.g., on its way to the first site, scheduled to go to the first site, etc.) to a second site.

In a third demonstrative example of the method 100 (e.g., as shown in FIGS. 10A-10C), in addition or alternative to those described above, vehicles arranged at the site function as mobile sensor stacks and can be used to create an environmental representation (e.g., map) of the site, which can, in turn, be used for any or all of: identifying that the site is fully filled and/or over-filled (e.g., as indicated by an overfill area and/or line of vehicles waiting for site access, an identification which is not part of the site management subsystem's understanding, an identification which is delayed at the site management subsystem due to a waiting for manual information to be input by non-fleet vehicles and/or site workers, etc.); a determination of a most efficient schedule and/or updated schedule (e.g., diversion to other sites until 1^{st} site is not congested) for other vehicles (e.g., in the fleet, outside of the fleet, etc.); an indication and/or alert to vehicles of objects which may be in another vehicle's blind spot (e.g., detection of Site worker 2 by V_3 which is communicated to V_2 prior to them departing Loading Dock 2); an indication or alert to site workers (e.g., warning that they may be in the blind spot of a non-fleet vehicle, indication that a vehicle to arrive at the site will instead head to another site first, etc.); and/or any other actions. In a particular example shown in FIGS. 10A-10C, for instance, an environmental representation in FIG. 10C is determined based at least in part on sensor information collected by vehicles (e.g., fleet vehicles) at Site 1, which is an up-to-date representation of the site in FIG. 10A, as opposed to the out-of-date representation (e.g., at the site management subsystem) which relies on manually entered information (e.g., from site workers, from non-AVs, from non-fleet vehicles) and/or non-comprehensive information (e.g., information which excludes non-vehicle information). The representation in FIG. 10C can optionally be used to: update that in FIG. 10B, communicate updated information to vehicles and/or site workers, and/or can be used in any other way(s).

Although omitted for conciseness, the preferred embodiments include every combination and permutation of the various system components and the various method processes, wherein the method processes can be performed in any suitable order, sequentially or concurrently.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

Additional or alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for controlling a fleet of autonomous vehicles associated with a set of customer sites, the method comprising:
receiving scheduling information from a site management subsystem associated with the set of customer sites;
controlling a first autonomous vehicle of the fleet of autonomous vehicles along a route to the first site based on the scheduling information;
while the first autonomous vehicle is located at the first site, collecting, at the first autonomous vehicle, a set of sensor information, the set of sensor information comprising at least one of camera and LIDAR data;
based at least in part on the set of sensor information, determining an environmental representation of at least a portion of the first site, wherein the environmental representation comprises:
a set of locations of a set of vehicles at the first site, the set of vehicles comprising the fleet of autonomous vehicles and a subset of vehicles that are separate and distinct from the fleet of autonomous vehicles; and
a set of locations of a set of humans at the first site;
transmitting the environmental representation to a fleet management subsystem, the fleet management subsystem in communication with the site management subsystem and the fleet of autonomous vehicles;
determining an updated set of control instructions for a second autonomous vehicle of the fleet of autonomous vehicles based on the environmental representation, wherein upon determining a discrepancy between the updated set of control instructions and a prior set of control instructions determined based on the scheduling information, preventing control of the second autonomous vehicle based on the prior set of control instructions;
controlling the second autonomous vehicle according to the updated set of control instructions.

2. The method of claim 1, wherein the updated set of control instructions automatically initiates a change in order of the first site relative to other sites in an ordered list of customer sites planned for the second autonomous vehicle.

3. The method of claim 2, wherein the environmental representation indicates that:
each of a set of loading docks at the first site is occupied; and
a set of waiting spots at the first site is at least partially occupied.

4. The method of claim 3, wherein the change in order comprises a delay of the first site relative to at least one of the other sites.

5. The method of claim 1, wherein determining the environmental representation further comprises determining a set of locations of a set of loading dock spots and a set of parking spots at the first site, such that the locations of the vehicles and the humans can be determined relative to the set of locations of the set of loading dock spots and the set of parking spots.

6. The method of claim 1, further comprising transmitting at least a subset of the environmental representation to the site management subsystem.

7. The method of claim 6, further comprising updating the scheduling information at the site management subsystem, wherein updating the scheduling information triggers an updated schedule to be transmitted to a non-fleet vehicle associated with the first site.

8. The method of claim 1, wherein the subset of vehicles comprises non-autonomous vehicles.

9. The method of claim 1, further comprising, for a third autonomous vehicle located at the first site concurrently with the first autonomous vehicle, using the set of sensor information to update a second set of control instructions associated with the third autonomous vehicle.

10. The method of claim 9, further comprising detecting that each of the first autonomous vehicle and third autonomous vehicle are located at the first site based on a geofence defining the first site.

11. The method of claim 9, wherein the updated second set of control instructions is configured to prevent the third autonomous vehicle from leaving a loading dock at the first site, wherein the sensor information indicates that an object is present in a blind spot of sensors of the third autonomous vehicle.

12. The method of claim 11, wherein controlling the third autonomous vehicle according to the updated second set of control instructions is triggered in response to receiving instructions from a user interface associated with a site worker that the third autonomous vehicle is free to leave the loading dock in response to completion of at least one of a loading process and an unloading process.

13. The method of claim 9, wherein the environmental representation identifies a number of vehicles that are waiting to enter the first site.

14. The method of claim 13, wherein the updated second set of control instructions are operable to re-route the third vehicle to a different area within the first site than originally planned.

15. The method of claim 1, further comprising, after determining the environmental representation, transmitting a notification operable to alter a trajectory of a non-fleet vehicle.

16. The method of claim 15, wherein the notification is transmitted to an application executing on a user device associated with a human driver of the non-fleet vehicle.

17. A system for controlling a fleet of autonomous vehicles associated with a set of customer sites, the system comprising:
a fleet management subsystem in communication with the fleet of autonomous vehicles and a site management subsystem, wherein the site management subsystem is operable to provide scheduling information for a set of vehicles, the set of vehicles comprising the fleet of autonomous vehicles, at at least a first site of the set of customer sites;
a set of sensor subsystems, each of the set of sensor subsystems onboard an autonomous vehicle of the fleet;
a set of processing subsystems associated with the fleet of autonomous vehicles and in communication with the fleet management subsystem, comprising a first processing subsystem associated with a first autonomous vehicle of the fleet of autonomous vehicle, the first processing subsystem in communication with a first sensor subsystem of the set of sensor subsystems, wherein the first processing subsystem is configured to:
provide a first set of control instructions operable to control travel of the first autonomous vehicle along a route to the first site based on the scheduling information;
while the first autonomous vehicle is located at the first site, collect sensor information comprising at least one of camera and LIDAR data from the first sensor subsystem;
based at least in part on the set of sensor information, determine an environmental representation of at least a portion of the first site, wherein the environmental representation comprises:
a set of locations of a subset of the set of vehicles located at the first site, the subset of vehicles comprising vehicles that are separate and distinct from the fleet of autonomous vehicles; and
a set of locations of a set of site workers at the first site;
transmit the environmental representation to the fleet management subsystem;
determine an updated set of control instructions for a second autonomous vehicle of the fleet of autonomous vehicles based on the environmental representation, wherein upon determining a discrepancy between the updated set of control instructions and a prior set of control instructions determined based on the scheduling information, preventing control of the second autonomous vehicle based on the prior set of control instructions; and
initiate control of the second autonomous vehicle according to the updated set of control instructions; and
a set of user interfaces associated with the set of site workers arranged at the first site.

18. The method of claim 17, wherein sensors of the first sensor subsystem sensors are fixed relative to the first autonomous vehicle and mobile relative to the first site.

19. The method of claim 17, wherein the first processing subsystem is further configured to receive inputs from the set of site workers via the set of user interfaces.

20. The method of claim 19, wherein the updated set of control instructions are further determined based on the inputs.
